(19) United States
(12) Patent Application Publication
(10) Pub. No.: US 2026/0290059 A1
(43) Pub. Date: Sep. 24, 2026

(54) METHOD FOR OBTAINING TEXT DATA CORRESPONDING TO ANALOG CHARACTERS AND COMPUTER READABLE MEDIUM STORING PROGRAM FOR OBTAINING TEXT DATA CORRESPONDING TO ANALOG CHARACTERS

(71) Applicant: SUNNET CO., LTD., Odawara-shi (JP)

(72) Inventors: Satoshi ICHIKAWA, Odawara-shi (JP); Kazuhito YOSHIDA, Odawara-shi (JP)

(21) Appl. No.: 19/086,327

(22) Filed: Mar. 21, 2025

(51) Int. Cl. G06V 30/19; G06V 30/148

(52) U.S. Cl. CPC G06V 30/19173; G06V 30/153; G06V 30/19093

(57) ABSTRACT

This invention addresses the issue of converting handwritten analog characters into text data with high recognition accuracy when they are the target of text data conversion in data input. The problem is solved by obtaining AI-recognized text data using an AI function that classifies handwritten text image data based on a combination of handwritten text image data and text data corresponding to the handwritten text image data. The problem is solved by performing such classification on data that has undergone recognition accuracy enhancement processing to improve the recognition accuracy of handwritten text image data by removing digital data that exists in the vicinity of the handwritten text image data other than digital data corresponding to handwritten character.

### TECHNICAL FIELD

This article is concerned with technology for converting analog characters consisting of handwritten character into text data. It also relates to technology for use in services that convert analog characters into text data, i.e., services known as data entry or verification input.

### BACKGROUND TECHNOLOGY

There are a large number of documents in the market that contain characters that have not been converted to text data, i.e., analog characters. The market has a service called “data entry,” in which analog characters are converted into text data. This service requires accurate conversion of analog characters into text data.

Data entry is typically performed as follows. Data entry is performed by the first text data acquisition by the first operator and the second text data acquisition by the second operator.

First, from a document containing analog characters to be converted into text data, text image data is obtained by capturing the analog characters as images and digitizing them. Next, so-called recognized text data is obtained from the text image data using OCR (Optical Character Recognition).

The first operator compares the text image data with the recognized text data, and if it determines that the text image data and the recognized text data match, it treats the recognized text data as the first text data as is. On the other hand, the first operator compares the text image data with the recognized text data, and if it determines that the text image data and the recognized text data do not match, it corrects the recognized text data to match the text image data, and treats the corrected one as the first text data.

The second operator compares the text image data with the first text data obtained by the first operator, and if it determines that the text image data and the first text data match, it treats the first text data as the second text data as is. On the other hand, the second operator compares the text image data with the first text data obtained by the first operator, and if it determines that the text image data and the first text data do not match, it corrects the first text data to match the text image data, and treats the corrected one as the second text data. In the data entry service, the second text data obtained by the second operator is treated as analog characters converted into text data. In the data entry service, through this combination of judgment by the first operator and judgment by the second operator, analog characters can be accurately converted into text data.

### PRIOR ART REFERENCES

### Patent Documents

[Patent Document 1] Patent Laid Open 2013-97393

[Patent document 2] Patent Laid Open 2008-152357

### SUMMARY OF INVENTION

### Problem to be Solved

In data entry, the recognized text data used by the first operator is obtained by processing with OCR. When processing with OCR, the recognition accuracy of the text is very high, exceeding 90% when the processing object is a typed character. As a result of the first operator's work using text data with recognition accuracy exceeding 90%, highly accurate first text data can be obtained. As a result, the second operator can verify the text data with high accuracy. By obtaining second text data through such a process, highly reliable text databasing can be achieved, and the data entry service is established.

On the other hand, when processing object is a handwritten character, recognition accuracy of the text by OCR processing is very low. For example, when a money amount consisting of several digits is handwritten, the character recognition rate of the recognized text data obtained by processing the entire money amount with OCR was 27.0%. Therefore, when performing data entry using such data, the first and second operators had to work very carefully, which was problematic in terms of time and effort expended. The problem of this invention is to obtain a means that can convert handwritten analog text characters into text data with high recognition accuracy when they are the object of text data conversion in data entry.

The development of technology to accurately convert handwritten character into text data has been desired but not solved, not only in the field of data entry, but also in other fields. Patent document 1 describes a system that makes it possible to read a handwritten character in notebooks with high accuracy. In this system, a text image data captured by a digital camera mounted on a smartphone is sent to a server in a center using a communication network, where the text image data is converted into text data. Conversion to text data is performed by two or more operators reading handwritten character and transmitting (inputting) the reading results from operator terminals. In other words, it relies on visual inspection by humans. In addition, by reading the characters in the handwritten area optically, text data conversion by OCR and input by the above operators coexist.

Patent document 2 describes a system for efficient recognition of handwritten input data. In this system, for example, image data of handwritten characters such as names of candidates on ballots are basically converted to text data using OCR, but data that cannot be converted and cannot be discriminated are sent to the person in charge, who then selects candidates from the handwritten characters by visual inspection.

### Means to Solve Problem

The following invention (1) solves the problem. (1) A method for acquiring text data corresponding to analog characters comprising handwritten characters, the method comprising: an AI-recognized text data acquisition step of acquiring AI-recognized text data by classifying handwritten text image data, which are digitized image data of said analog characters, using an AI feature based on a combination of said handwritten text image data and text data corresponding to said handwritten text image data; a first text data acquisition step in which said handwritten text image data and said AI-recognized text data are compared, and those among the AI-recognized text data determined to match the handwritten text image data are acquired as-is as first text data, and those among the AI-recognized text data determined not to match the handwritten text image data are corrected to match the handwritten text image data and acquired as the first text data; a second text data acquisition step in which said handwritten text image data and said first text data are compared, and those among the first text data determined to match the handwritten text image data are acquired as-is as second text data, and those among the first text data determined not to match the handwritten text image data are corrected to match the handwritten text image data and acquired as the second text data; wherein the analog characters, which are handwritten characters, are arranged in square cells, and in said AI-recognized text data acquisition step, the handwritten text image data are segmented character-by-character in accordance with said square cells to acquire text data corresponding to the analog characters.

The following invention (2) solves the problem. (2) The method for acquiring text data corresponding to analog characters according to (1), wherein said handwritten characters are numerals.

The following invention (3) solves the problem. (3) The method for acquiring text data corresponding to analog characters according to (1), wherein said AI feature classifies data on which recognition accuracy improvement processes have been performed to improve recognition accuracy of the handwritten text image data, and the recognition accuracy improvement processes include removing digital data existing around the handwritten text image data that do not correspond to the handwritten characters.

The following invention (4) solves the problem. (4) The method for acquiring text data corresponding to analog characters according to (3), wherein said AI feature classifies data on which recognition accuracy improvement processes have been performed to improve recognition accuracy of the handwritten text image data, and the recognition accuracy improvement processes include removing digital data indicating boundaries of said square cells.

The following invention (5) solves the problem. (5) A program for acquiring text data corresponding to analog characters comprising handwritten characters, the program comprising: an AI-recognized text data acquisition unit for acquiring AI-recognized text data by classifying handwritten text image data, which are digitized image data of said analog characters, using an AI feature based on a combination of said handwritten text image data and text data corresponding to said handwritten text image data; a first text data acquisition unit in which said handwritten text image data and said AI-recognized text data are compared, and those among the AI-recognized text data determined to match the handwritten text image data are acquired as-is as first text data, and those among the AI-recognized text data determined not to match the handwritten text image data are corrected to match the handwritten text image data and acquired as the first text data; a second text data acquisition unit in which said handwritten text image data and said first text data are compared, and those among the first text data determined to match the handwritten text image data are acquired as-is as second text data, and those among the first text data determined not to match the handwritten text image data are corrected to match the handwritten text image data and acquired as the second text data; wherein said analog characters comprising handwritten characters are arranged in accordance with square cells, and said AI-recognized text data acquisition unit segments the handwritten text image data character-by-character in accordance with said square cells to acquire text data corresponding to the analog characters; wherein the program is recorded on a computer-readable recording medium.

The following invention (6) solves the problem. (6) The computer-readable recording medium according to (5), wherein said handwritten characters are numerals.

The following invention (7) solves the problem. (7) The computer-readable recording medium according to (5), wherein said AI feature classifies data on which recognition accuracy improvement processes have been performed to improve recognition accuracy of the handwritten text image data, and the recognition accuracy improvement processes include removing digital data existing around the handwritten text image data that do not correspond to the handwritten characters.

The following invention (8) solves the problem. (8) The computer-readable recording medium according to (7), wherein said AI feature classifies data on which recognition accuracy improvement processes have been performed to improve recognition accuracy of the handwritten text image data, and the recognition accuracy improvement processes include removing digital data indicating boundaries of said square cells.

AI learns analog characters consisting of handwritten character by using a combination of image data of handwritten character and correct text data corresponding to the handwritten character as teacher data. The AI is able to classify various image data of handwritten character into text data corresponding to the handwritten character. Through such classification, it is possible to obtain data recognized as text data corresponding to the handwritten text image data. The data recognized as text data corresponding to the handwritten text image data is referred to as AI-recognized text data in this document.

When such analog characters consisting of handwritten character are aligned with the square cells, in the AI-recognized text data acquisition step, handwritten text image data can be acquired by separating each character according to the square cell.

Normally, when writing by hand, each character is of a different size and is positioned at different heights and widths. Therefore, it is usually difficult to separate each character by CPU processing in handwritten character. However, in the case of handwritten character entered into pre-defined square cells, the possibility of a single character being placed in a single square cell is increased by dividing the character into square cells. In handwritten letters, there are cases where two letters may be placed in contact with each other or where one letter may be separated into two separate letters, so it is significant that the possibility of a single letter fitting into a single square cell is increased. As a result, analog data consisting of handwritten character can be converted to digital data with a high character recognition rate. As a result, the efficiency of data input of analog data consisting of handwritten character is greatly increased, and the time and labor required for verification input can be greatly reduced.

Some documents that are subject to data input, such as accounting slips, have fixed input columns in the document, and the input columns have square cells for writing characters in advance, and the input person writes handwritten character in accordance with the square cells. In such documents, handwritten letters are divided into square cells, and the AI can learn each one letter by using the fact that the handwritten letters are written in accordance with the square cells.

Usually, data such as ruled lines written on the paper on which the handwritten characters are to be written before the handwritten character are written, parts of other handwritten character adjacent to the handwritten character, dirt, etc. remain in the vicinity of the handwritten text image data.

Such data can hinder the correct conversion of handwritten text image data into text data. When handwritten text image data is subject to training by AI, such data should be removed. When handwritten text image data is subjected to training by AI, the process of removing digital data other than digital data corresponding to handwritten character is applied to improve the recognition accuracy of the handwritten text image data.

As for the digital data indicating the boundaries of the square cells, even though it is obvious that they are not part of the handwritten character, they often overlap with the handwritten character because they are located extremely close to the handwritten character. On the other hand, the position data of the digital data indicating the boundaries of the square cells can be easily removed because it can be known in advance. Therefore, removing the digital data indicating the boundaries of the square cells is of great significance as one of the recognition accuracy improvement processes.

There are various types of digital data that show the boundaries of square cells, such as ruled lines that surround the top, bottom, left, and right sides of the square cells, ruled lines that only show the left and right sides, and colored parts that show the location of the square cells. There are also various types of ruled lines, such as solid lines, dotted lines, etc.

Some items are “money amount” or “date” and the characters to be input are only numbers. In such cases, the AI's learning target can be limited to numbers only. By doing so, the learning target can be limited to 10 types, namely 0, 1, 2, 3, 4, 5, 6, 7, 8, and 9.

As shown in FIG. 11, there are many ruled lines and noises around the handwritten character. We assumed that such ruled lines and noises prevent the correct correspondence of image data with text data, so we removed such ruled lines and noises and trained the AI, and the character recognition rate was 89.7%.

In the case of handwritten characters are written in cells, there are square cells without characters in the items. By excluding such cells from AI processing target, the amount of AI work can be reduced.

### Effects of the Invention

Handwritten analog characters can be converted into digital data with a high character recognition rate. As a result, the efficiency of data input of analog data consisting of handwritten character is greatly increased, and the time and effort spent on data input can be greatly reduced.

### BRIEF DESCRIPTION OF THE DRAWING

FIG. 1: Hardware configuration of the administrator terminal 1 in Working example 1

FIG. 2: The structure of the data communication network in Working example 1

FIG. 3: The overall steps of the “System for acquiring item text data used for verification” in Working example 1

FIG. 4: Process for acquiring the item image data of AI-processing target item (Step 1) in Working example 1

FIG. 5: Process for deleting ruled line (Step 2-1) in Working example 1

FIG. 6: Process for removing noise (step 2-2) in Working example 1

FIG. 7: (step 2-3) in Working example 1

FIG. 8: Process for excluding blank text image data for one character (Step 2-4) and (Step 3-1) in Working example 1

FIG. 9: Process for acquiring AI-recognized text data (Step 3-2) in Working example 1

FIG. 10: Process for acquiring item text data for verification (Step 4) in Working example 1

FIG. 11: Image data after the processing of Working example 1 and image data without processing of Working example 1

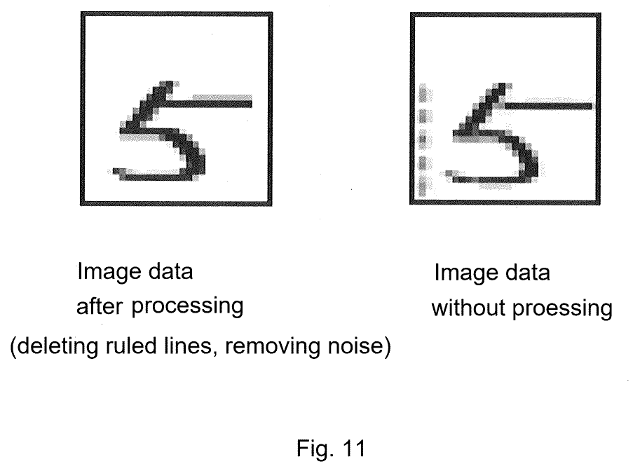

### DESCRIPTION OF SIGN

1 System administrator terminal
2 Control section
3 CPU
4 ROM
5 RAM
6 Input device
7 Display device
8 Communications controller
9 Bus line
10 Storage device
11 Data storage section
12 Program storage section

### Working Example

The following is a description of a suitable embodiment of the invention with reference to the drawings.

### Working Example 1

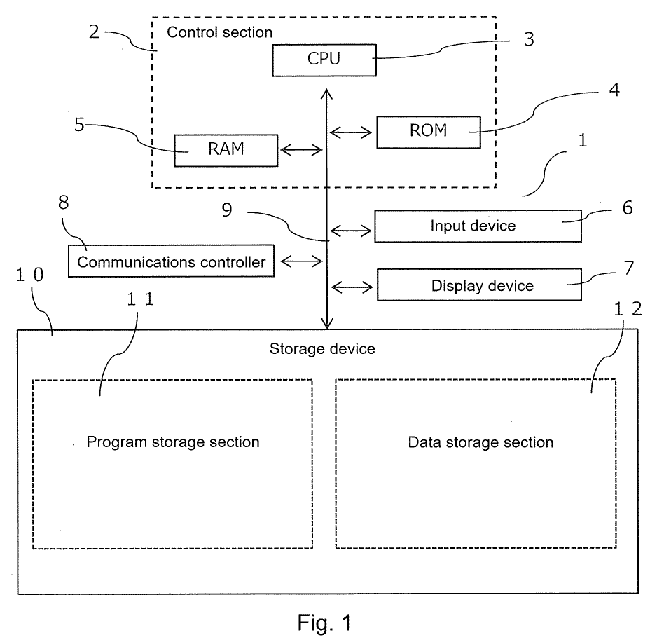

FIG. 1 represents the hardware configuration of the administrator terminal 1. The administrator terminal 1 has a control section 2 for controlling the entire system as shown in FIG. 1. To this control section 2, an input device 6, a display device 7, a communication controller 8, and a storage device 10 are connected via a bus line 9 such as a data bus.

The control section 2 has a CPU 3, ROM 4, and RAM 5. The CPU 3 performs various data processing and control according to programs stored in various storage areas such as ROM 4 and storage device 10. ROM 4 is a read-only memory in which various programs and data for the CPU 3 to perform various controls and operations are stored in advance. RAM 5 is a read-only memory. RAM5 is a random access memory used by CPU 3 as a working memory. Various areas can be reserved in this RAM 5 to perform various types of processing according to this system.

The input device 6 is arranged with a keyboard, mouse, touch panel, etc. (not shown in the figures). The keyboard has various keys, such as keys for character input, a numeric keypad for entering numbers, function keys for executing various functions, cursor keys, and the like. The mouse is a pointing device and an input device for specifying corresponding functions by clicking keys, icons, etc. displayed on the display unit 7. The touch panel is an input device placed on the surface of the display unit 7, which identifies the user's touch position corresponding to the various operation keys displayed on the screen on the display unit 7 and accepts input of the operation keys displayed in response to that touch position.

The display device 7 uses a CRT or liquid crystal display. This display device shows the results of keyboard or mouse input or displays image data.

The Communications controller 8 is a control device for network connection between the system administrator terminal 1 and various external electronic devices such as other personal computers. The Communications controller 8 allows access to the system administrator terminal 1 from these various external electronic devices, and allows input of search condition sentences from the external electronic devices.

The storage device 10 consists of a read/write storage medium and a drive unit for reading and writing programs and various data to and from the storage medium. The storage medium used for the storage device 10 is mainly a hard disk. The storage device 10 has a data storage section 11, a program storage section 12, and other storage sections (e.g., a storage section for backing up programs, data, etc. stored in this storage device 10) not shown. The data storage section 11 stores data required by the system in this embodiment, as described below. The program storage section 12 stores the various processing programs in this implementation, as described below.

The system administrator terminal 1 in this embodiment can be configured not only by a computer system, but also by a server in a LAN, a host for computer communications, or a computer system connected on the Internet. It is also possible to distribute the functions to each device on the network and have the entire network have the same configuration as the system administrator terminal 1.

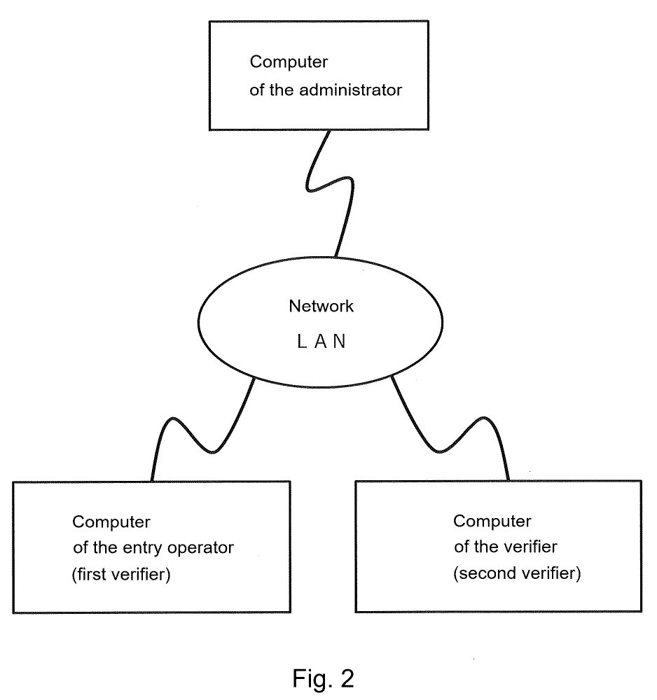

As shown in FIG. 2, the verification system consists of a computer of the administrator, a computer of the entry operator (first verifier), and a computer of the verifier (second verifier) connected by a data communication network such as a network or LAN. The verification system can be composed not only by a computer system, but also by a server of LAN, a host of computer communication, or a computer system connected on the Internet.

As shown in FIG. 1, the storage device 10 has a program storage section 11 and a data storage section 12.

The program storage section 11 contains programs for having the computer perform each of the following processes. All of them are processed by the CPU of the administrator's computer.
(1) Item image data acquisition process for items subject to AI processing
(2) Process for deleting ruled line
(3) Process for removing noise
(4) Process for deleting margin data
(5) Process for excluding blank text image data for one character
(6) Process for acquiring text image data for one character to be processed by AI
(7) Process for acquiring AI-recognized text data
(8) Process for acquiring item text data for verification

The following data is pre-recorded in the data storage section 12.
(1) Location data of item image data for each verification target
(2) Data on items that should be subject to AI processing
(3) Item text data
(4) Ruled line position data
(5) Data subject to margin processing
(6) AI-recognized text data
(7) Other data

The data storage section 12 records all data acquired in the course of each program execution.

Terms in this specification are defined as follows
“whole image data” is the image data obtained by digitizing the whole document containing the “item” that is the verification target (i.e., the target for converting analog text into text character data).
“item” is an item in a document to be verified that is considered a unit to be verified, such as date, name, and invoice amount.
“items to be processed by AI” are items that are listed in advance as items to be processed by AI.
“Item image data” is the image data of an item.
“Item text data” is the text data of an item.
“Item position data” is digital data that indicates the position of an item on the document.
“text image data for one character” is the image data of a single character.
“text data for one character” is text data of a single character.
“recognition accuracy improvement process” is a process to improve the accuracy of converting image data to text data.
“Ruled line position data” is digital data indicating the position of ruled lines in an item.
“Character position data” is digital data that indicates the position of a character in an item.
“data for margin processing” is digital data that indicates the position of the margins in the item.
“AI processing” is the process of classifying text image data for one character into text data for one character. In obtaining the corresponding text data from the text image data, “AI-Recognized text data” is used.
“AI-Recognized text data” is text data tied to each of the 10 types of text image data for one character of numbers (0, 1, 2, 3, 4, 5, 6, 7, 8, 9). This data is acquired through AI processing.
“OCR processing” is the process of acquiring text data from image data using existing Optical Character Recognition.
“S” in each figure refers to a step.

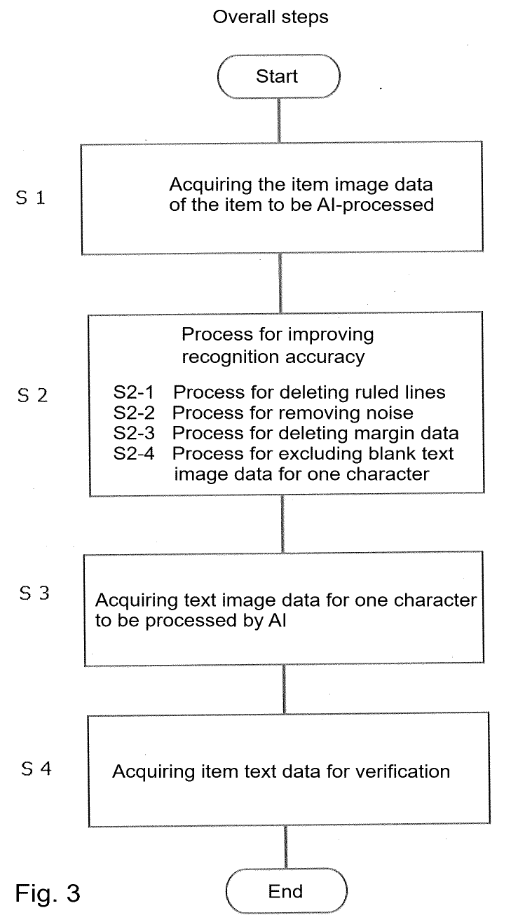

FIG. 3 shows a flowchart of the overall steps of Working example 1, “System for acquiring item text data used for verification”.

### Step 1

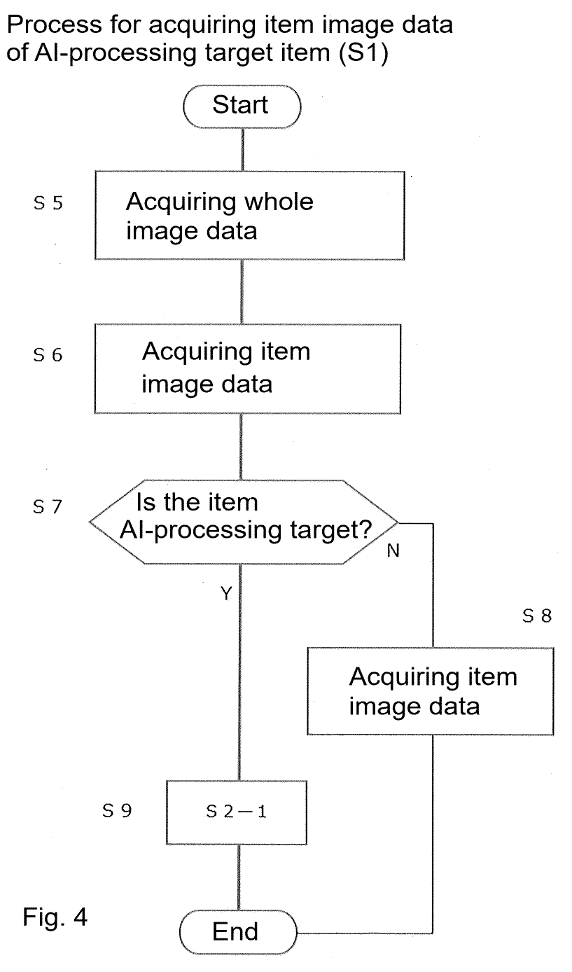

The CPU acquires and saves the item image data of the item to be AI-processed from the document to be verified. Details of Step 1 are shown in Steps 5 through 9 of FIG. 4.

### Step 2

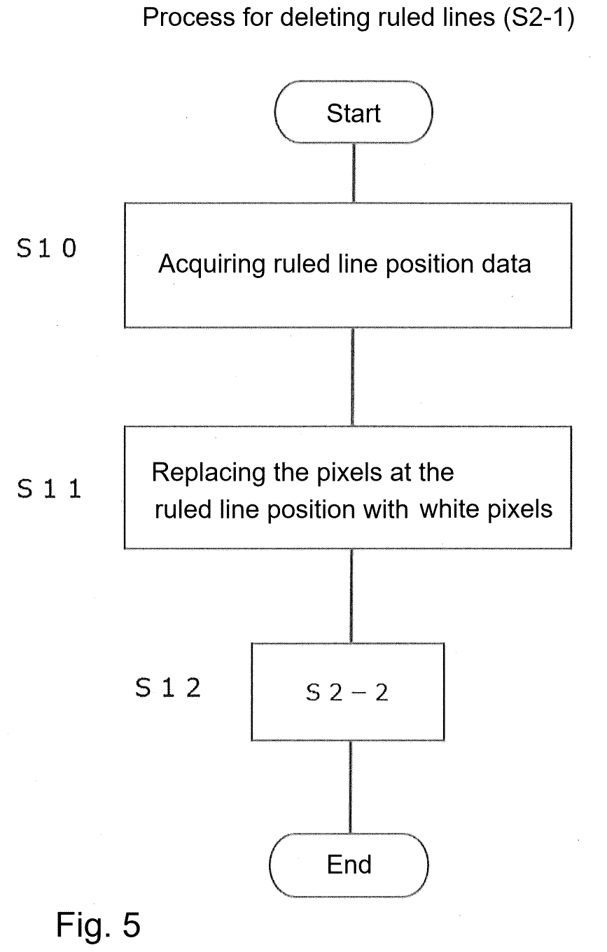

The CPU performs recognition accuracy improvement processing with respect to item image data. Specifically, process for deleting ruled line (Step 2-1), Process for removing noise (Step 2-2), Process for deleting margin data (Step 2-3), and Process for excluding blank text image data for one character (Step 2-4) are performed. (Step 2-4). The programs for each process are recorded in the data storage section. The process for deleting ruled line and the process for deleting noise are always performed in the following order: process for deleting ruled line, process for removing noise, and so on. The deletion process of margins is performed only when there are margins. After applying the recognition accuracy improvement process, each data is saved. The details of Step 2 are shown in Steps 10 to 22 in FIGS. 5 to 8.

### Step 3

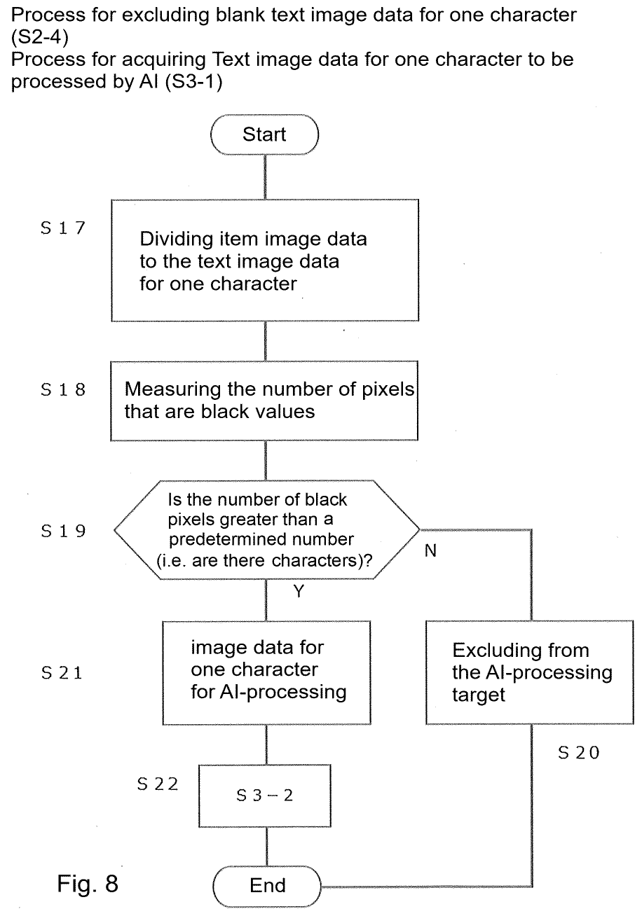

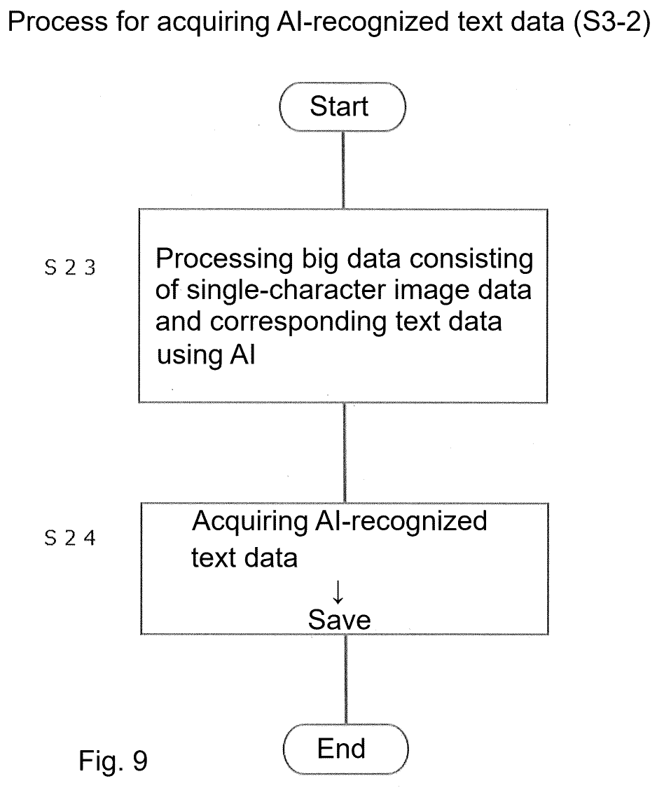

The CPU performs AI processing on the text data items that have undergone recognition accuracy improvement processing and are subject to AI processing, acquires AI-recognized text data, and saves it. Specifically, step 17 in FIG. 8 to step 24 in FIG. 9.

### Step 4

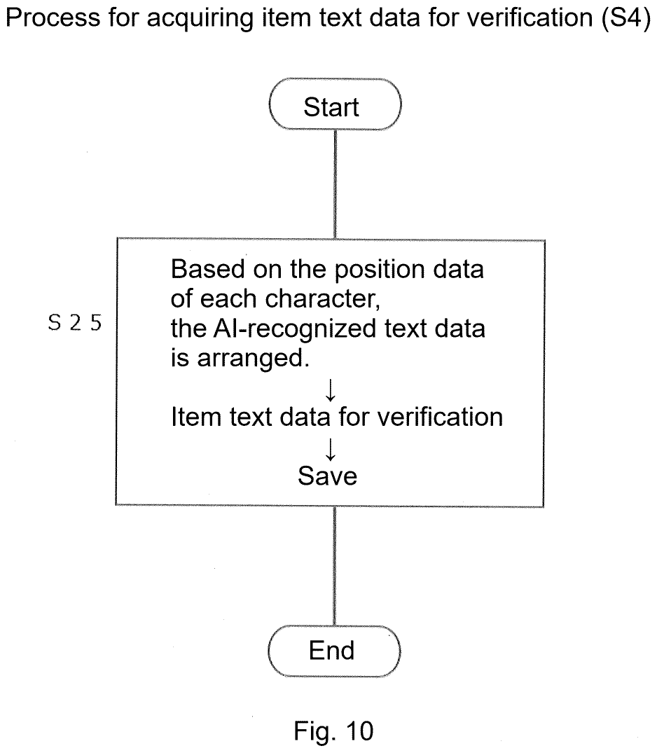

The CPU performs the item text data for verification acquisition process and saves it. Specifically, it is shown in step 25 of FIG. 10. In the verification process, the first operator uses the item text data used for verification in acquiring the first text data.

FIG. 4 shows a flowchart of each step in the item image data acquisition process (Step 1) of AI processing target item.

### Step 5

The CPU digitizes the analog characters of the entire document to be verified (e.g., an entire accounting slip) using a scanner to obtain the entire image data (i.e., the image data obtained by digitizing the entire document including the items to be verified). In Step 5, the CPU obtains such overall image data and stores it in the data storage section together with the document data to be verified.

### Step 6

The document to be verified contains items such as date, name, amount billed, etc. (i.e., items that are the unit of measure when verifying), depending on the contents of the document. Each item is placed at a fixed position in the document to be verified, i.e., the document to be verified is standardized. Therefore, the position data of each item image data is obtained in advance and recorded in the data storage section for each document to be verified.

The CPU can obtain the position data of the desired item image data by using the written data of the verification target obtained in step 5 and the position data of the item image data for each verification target recorded in advance.

The CPU retrieves the desired item image data from the overall image data using the position data of the item image data thus retrieved and stores it in the data storage section.

### Step 7

The following conditions must be met: (1) The characters used in the item must be numeric, and (2) The characters listed in the item must be separable by single characters. Items that satisfy these conditions are designated as items subject to AI processing and are recorded in advance in the data storage section as “AI processing target item data.”

The CPU acquires “item data” and “item data subject to AI processing” and determines whether the item is subject to AI processing.

### Step 8

If the item is not subject to AI processing, the CPU obtains and saves the item text data (i.e., item text data) from the item image data (i.e., item image data) by OCR processing and terminates step 1.

### Step 9

If the item is subject to AI processing, the CPU performs Step 2-1 [deletion of ruled line data] and terminates Step 1.

FIG. 5 shows a flowchart of each step in the Process for deleting ruled line (step 2-1).

### Step 10

The CPU obtains ruled line position data (i.e., digital data indicating the position of the ruled line in the item) from the data storage section.

### Step 11 The CPU replaces the pixels at the ruled line position with white pixels and stores the replaced item image data in the data storage section.

### Step 12

The CPU starts Step 2-2 [Process for deleting Nois] and ends Step 2-1 [Process for deleting ruled line].

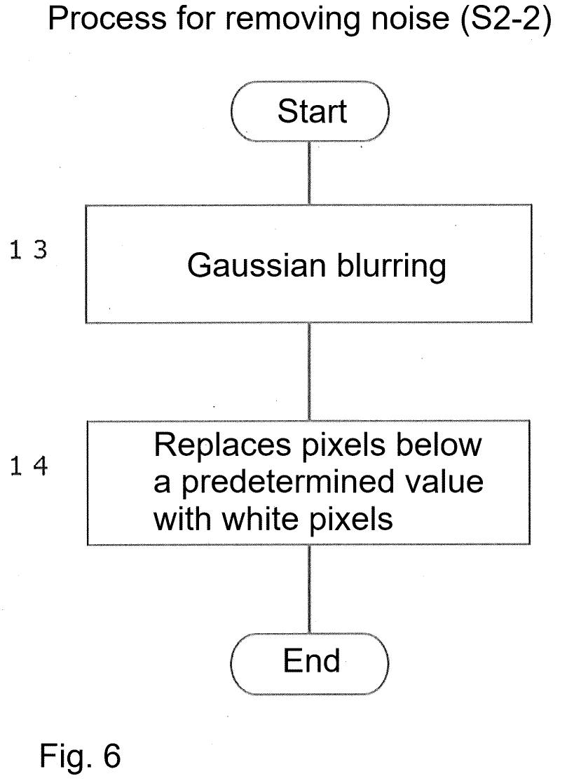

FIG. 6 shows a flowchart of each step in the process for removing noise (Step 2-2).

### Step 13

The CPU applies Gaussian blurring to each pixel of the item image data.

### Step 14

The CPU replaces pixels below a predetermined value (e.g., below 150 steps of the grayscale image) with white pixels. The process ends with saving the replaced item image data in the data storage section.

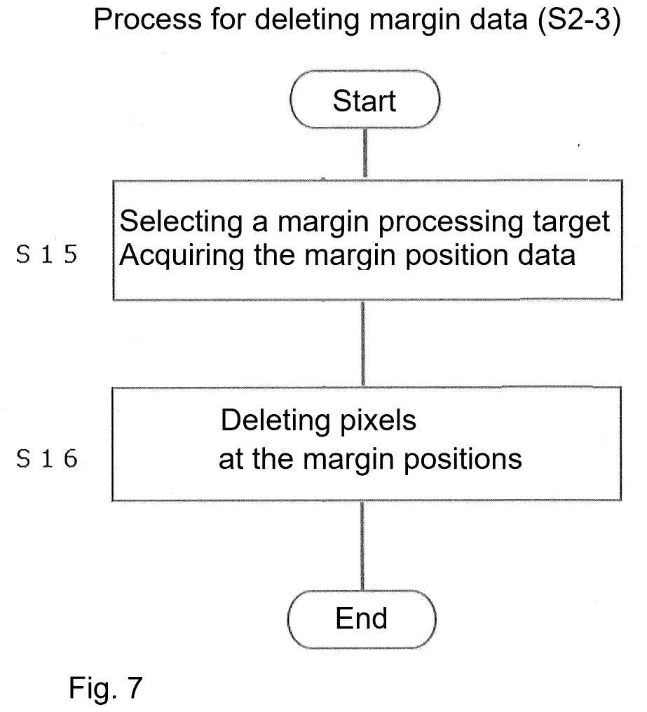

FIG. 7 shows a flowchart of each step in the process for deleting margin data (Step 2-3). For example, if the space allocated to each character in an item is long in the vertical direction, there will be a space above the space allocated to each character where no character is present. The margins here refer to such areas with no text. The location of the margins is known in advance for each item. The position of the margins in each item is recorded in advance for each item as the margin position data.

### Step 15

The CPU selects a margin processing target. The CPU acquires the margin position data (i.e., digital data indicating the position of the margins in the item) in the margin processing target.

.

### Step 16

The CPU deletes pixels at the margin positions. The deleted item image data is saved in the data storage section and the process is terminated.

FIG. 8 shows the Process for excluding blank text image data for one character (Step 2-4). FIG. 8 also shows a flowchart of each step in (Step 3-1), the process of acquiring text data for one character through AI processing.

### Step 17

The CPU acquires ruled line position data from the data storage section. The CPU divides item image data at the ruled line position and acquires text image data for one character. The CPU stores the position data of text image data for one character in the item image data together with the text image data for one character.

### Step 18

The CPU measures the number of pixels that are black values for each text image data one character.

### Step 19

The CPU determines whether the number of black pixels in the text image data for one character is greater than or equal to a predetermined number (e.g., greater than 7% of the number of image pixels). If the number of black pixels in the text image data for one character is greater than or equal to a predetermined number, it can be determined that a character exists in the text image data for one character, and if it is less than or equal to a predetermined number, it can be determined that no character exists in the text image data for one character.

### Step 20

If the number of black pixels in the text image data for one character is not more than a predetermined number in step 19, the CPU excludes the concerned text image data for one character from the AI processing and terminates the Process for excluding blank text image data for one character (step 2-4). This is because the relevant text image data for one character is judged to be blank (no characters). By excluding blank text image data for one character from AI processing, meaningless AI processing can be eliminated.

### Step 21

If the number of black pixels in the text image data for one character in step 19 is greater than a predetermined number, the CPU makes that text image data for one character text image data for one character to be processed by AI.

### Step 22

The CPU starts Step 3-2 [AI processing] for text image data for one character to be processed by AI, and completes Step 3-1 [AI processing to obtain text data for one character].

FIG. 9 shows a flowchart of each step in the process for acquiring AI-recognized text data (Step 3-2).

### Step 23

Process big data consisting of combinations of image data for one character and corresponding text data using AI, and classify the image data for one character. As a result of the AI processing, AI-recognized text data (i.e., image data for one character corresponding to 10 types of numbers (0, 1, 2, 3, 4, 5, 6, 7, 8, 9) and text data corresponding to each image data for one character) is obtained.

### Step 24

The AI-recognized text data obtained in step 23 is stored in the data storage section.

FIG. 10 shows a flowchart of each step in the process of acquiring item text data for verification.

### Step 25

Based on the position data of each character in the “text image data for one character”, the CPU arranges each AI-recognized text data so that it matches the positional relationship of each corresponding “single character mage data. The AI-recognized text data arranged in such a manner shall be saved and used as item text data for verification by the first operator. The process is terminated.

1. A method for acquiring text data corresponding to analog characters composed of handwritten characters, the method comprising:
an AI-recognized text data acquisition step of acquiring AI-recognized text data by classifying handwritten text image data, which are digitized image data of said analog characters, using an AI feature based on a combination of said handwritten text image data and text data corresponding to said handwritten text image data;
a first text data acquisition step in which said handwritten text image data and said AI-recognized text data are compared, those of the AI-recognized text data determined to match the handwritten text image data are acquired as-is as first text data, and those of the AI-recognized text data determined not to match the handwritten text image data are corrected to match the handwritten text image data and acquired as the first text data;
a second text data acquisition step in which said handwritten text image data and said first text data are compared, those of the first text data determined to match the handwritten text image data are acquired as-is as second text data, and those of the first text data determined not to match the handwritten text image data are corrected to match the handwritten text image data and acquired as the second text data;
wherein said analog characters composed of handwritten characters are arranged in accordance with square cells,
and in said AI-recognized text data acquisition step, the handwritten text image data are segmented character-by-character in accordance with said square cells to acquire text data corresponding to the analog characters.

2. The method for acquiring text data corresponding to analog characters according to claim 1, wherein said handwritten characters are numerals.

3. The method for acquiring text data corresponding to analog characters according to claim 1,
wherein said AI feature classifies data on which recognition accuracy improvement processes have been performed to improve recognition accuracy of the handwritten text image data, and the recognition accuracy improvement processes include removing digital data located around the handwritten text image data that do not correspond to the handwritten characters.

4. The method for acquiring text data corresponding to analog characters according to claim 3,
wherein said AI feature classifies data on which recognition accuracy improvement processes have been performed to improve recognition accuracy of the handwritten text image data, and the recognition accuracy improvement processes include removing digital data indicating boundaries of said square cells.

5. A program for acquiring text data corresponding to analog characters composed of handwritten characters, the program comprising:
an AI-recognized text data acquisition unit for acquiring AI-recognized text data by classifying handwritten text image data, which are digitized image data of said analog characters, using an AI feature based on a combination of said handwritten text image data and text data corresponding to said handwritten text image data;
a first text data acquisition unit in which said handwritten text image data and said AI-recognized text data are compared, those of the AI-recognized text data determined to match the handwritten text image data are acquired as-is as first text data, and those of the AI-recognized text data determined not to match the handwritten text image data are corrected to match the handwritten text image data and acquired as the first text data;
a second text data acquisition unit in which said handwritten text image data and said first text data are compared, those of the first text data determined to match the handwritten text image data are acquired as-is as second text data, and those of the first text data determined not to match the handwritten text image data are corrected to match the handwritten text image data and acquired as the second text data;
wherein said analog characters composed of handwritten characters are arranged in accordance with square cells, and said AI-recognized text data acquisition unit segments the handwritten text image data character-by-character in accordance with said square cells to acquire text data corresponding to the analog characters;
wherein the program is recorded on a computer-readable recording medium.

6. The computer-readable recording medium according to claim 5, wherein said handwritten characters are numerals.

7. The computer-readable recording medium according to claim 5, wherein said AI feature classifies data on which recognition accuracy improvement processes have been performed to improve recognition accuracy of the handwritten text image data, and the recognition accuracy improvement processes include removing digital data located around the handwritten text image data that do not correspond to the handwritten characters.

8. The computer-readable recording medium according to claim 7, wherein said AI feature classifies data on which recognition accuracy improvement processes have been performed to improve recognition accuracy of the handwritten text image data, and the recognition accuracy improvement processes include removing digital data indicating boundaries of said square cells.
